(19) United States
(12) Patent Application Publication
(10) Pub. No.: US 2021/0077349 A1
(43) Pub. Date: Mar. 18, 2021

(54) MULTIPURPOSE HANDHELD MASSAGE TOOL

(71) Applicant: Morgan Fredrick Smith, San Francisco, CA (US)

(72) Inventor: Morgan Fredrick Smith, San Francisco, CA (US)

(21) Appl. No.: 16/574,952

(22) Filed: Sep. 18, 2019

(51) Int. Cl. A61H 39/04; A61H 23/02; A61H 99/00

(52) U.S. Cl. CPC A61H 39/04; A61H 2201/0153; A61H 99/00; A61H 23/02

(57) ABSTRACT

This device is a handheld tool intended for use on one's self or another to provide various types of Massage therapy including: Direct Compression, Acupressure, Trigger Point Therapy, Muscle Scraping/Gua Sha, Lymphatic Drainage and Myofascial Release. The size and solid-body construction of this device make it easy to hold, easy to control, and quite durable. The unit is comprised of two distinct parts, a Knuckle Structure and a ball base.

The Knuckle Structures are distributed around and embedded in the ball base in a tetrahedral arrangement. The Knuckle Structures emerge from the ball base at graduated heights allowing for varying depths of penetration of the Knuckle Structures which allows for a greater level of safety and control when providing Trigger Point Therapy, Cross Friction Massage, and compressive forms of Myofascial Release. The sides of the Knuckle Structures provide a rounded edge, especially well-suited for Muscle Scraping which are gentler than those currently offered in other devices. The angles made by the juxtaposition of the Knuckle Structures and the ball base produce approximately V-shaped edges appropriate for lymphatic drainage. The smooth rounded surface of the ball-base itself is similarly appropriate for working on sensitive structures, where no penetration is desired, or for producing a stimulatory effect on underlying inflammation.

### TECHNICAL FIELD

This invention relates generally to the field of massage therapy and manual massage tools. More specifically, this invention relates to a new and useful handheld tool which provides a unique point of contact and combines specific aspects of multiple different massage techniques into a single, uniquely effective and safe hand-held device.

### BACKGROUND

In the United States, approximately 38% of adults (4 in 10) are using some form of Complementary and Alternative Medical (CAM) modality. While herbal supplements are the most commonly used CAM therapy among adults, the use of alternative modalities in general (including massage) is on the rise. (“The Use of Complementary and Alternative Medicine in the United States,” 2011) In 2002 the use of massage was estimated to be around 5% in the adult population which grew to 8.3% in 2007.

The 2012 National Health Interview Survey (NHIS) found that 6.9% of all U.S. adults (15.4 million) used massage therapy. In massage therapy, the therapist works on muscles and other soft tissues to help a person feel better. Preliminary evidence indicates that massage may help with back pain and may improve quality of life for people with cancer, depression, or HIV/AIDS. (“6.9% of U.S. adults (15.4 million) used Massage Therapy,” 2014)

An analysis from the 2012 NHIS also found that most American adults have experienced some level of pain. An estimated 25.3 million adults (11.2%) experience chronic pain, and nearly 40 million adults (17.6%) experience severe pain. Pain is one of the leading reasons Americans turn to complementary health approaches which may help manage pain. (“NIH Analysis Shows Americans Are In Pain,” 2015)

While potentially beneficial for pain massage therapy can be expensive, especially when used consistently. It has been suggested that several hour-long sessions per week may be the best “dose” for people with chronic neck pain. (“Multiple 60-Minute Massages per Week Offer Relief for Chronic Neck Pain,” 2014) Individual sessions typically range in cost from $50-$150 depending on session length and region of residence. The 2012 NHIS estimates that beyond what insurance covers, Americans spend about $30.2 billion yearly out-of-pocket on complementary health products and practices. An estimated $14.7 billion was spent for visits to practitioners such as chiropractors, acupuncturists, and massage therapists. About $2.7 billion was spent on self-care approaches. (“Paying for Complementary and Integrative Health Approaches|NCCIH,” n.d.)

With the widespread nature of pain in American society and the potential high cost of Alternative Medical treatment, there has been a burgeoning of self-treatment tools in the market. While most tools have not been studied directly, many of them proport to deliver types of therapy that have been researched: deep tissue massage, therapeutic massage, myofascial release, graston technique, trigger point therapy, and lymphatic drainage. Self-Myofascial release via foam roller, for example, has been found to increase range of motion (MacDonald et al., 2013); compressive trigger point therapy has been found to decrease muscle stiffness in professional athletes (Kisilewicz et al., 2018); lymphatic drainage has been found to be effective for lymphedema (Ezzo et al., 2015) and compartment syndrome (Pereira de Godoy & de Fátima Guerreiro Godoy, 2018); and Graston Technique has been found to be effective for hamstring flexibility and low back pain (Moon, Jung, Won, & Cho, 2017).

Massage is generally considered to be safe, but there can be side-effects that aren't as often discussed. (“Massage Therapy for Health Purposes,” 2011) Deep Tissue Massage for example has been found to have favorable outcomes in pain populations and to help increase range of motion, but the forceful application of massage therapy has also been associated with serious adverse events. (Koren & Kalichman, 2018) The Graston technique can be effective for increasing hamstring flexibility, but it can also be accompanied by profound bruising.

Massage tools generally fall into one of two categories: electric and manual. Manual tools themselves tend to fall into one of two categories: compressive and scraping. Compressive tools (two examples being the Theracane and Backnobber) usually take the form of a ball-shaped point of contact that is used to compress muscles. The point of contact may be attached to some sort of a handle for direct compression or to a cane/rod so that pressure may be placed more remotely on harder to reach structures (such as on the shoulders and back). Compressive tools may offer treatment surfaces of differing size, but the point of contact is almost universally a sphere. Scraping tools (such as those used in Gua Sha and Graston Technique) offer a rounded flat-edge that is used to manually break up scar tissue. Differences in these tools tend to be in the overall shape of the tool (e.g. S-shaped vs shark's tooth) and composition (e.g. metal vs. plastic vs. bison horn or stone).

Direct pressure into a muscle using a specific point of contact produces a point-specific stretch for tight muscle fibers. Direct compression is used in many different contexts and can take on many different labels. This type of therapy is especially effective for those with painful knots in their muscles and in that context is called myofascial release therapy. If direct pressure on such a knot produces a pain referral pattern, this type of therapy is labeled trigger point massage and is used to treat the pain referral patterns. If rather than holding still on the area of tightness the point of contact is moved back and forth, the therapy Is labelled cross-friction massage. Cross-friction massage is especially effective for breaking up scar tissue which is deposited as part of the healing process following a muscle strain or ligament sprain. Direct and sustained pressure is also used in Eastern Medicine to improve the movement of vital energy (AKA Qi) through underlying channels in the body/facia (AKA Meridians). In this context, direct pressure is known as Acupressure.

Muscle Scraping has existed in various forms for thousands of years. In Traditional Chinese Medicine it is typically called Gua Sha and less often referred to as skin scraping, spooning or coining. In Western Medicine it is generally called muscle scraping. Specific technique systems for muscle scraping with proprietary tools have also been developed (e.g. Graston Technique). The goals of muscle scraping are to break up scar tissue, stimulate circulation, and to treat muscle pain and tension. In Eastern traditions it is also used to stimulate the movement of stagnant qi in the body.

Lymphatic Drainage was developed as a form of massage to address stagnant inflammation. This type of inflammation often accumulates following surgeries where lymph nodes/vessels are damaged or removed. More than one in five breast cancer patients will develop breast cancer-related lymphedema. (Ezzo et al., 2015, p. 5) Lymph often accumulates in the extremities but may also collect in the chest wall, upper arm, or thigh. The mechanism of action for this type of massage is to gently push the accumulated inflammation back into the circulatory and lymph systems. To do this the therapist uses long and gentle strokes moving from the extremities in the direction of the heart.

### BRIEF SUMMARY

The preferred device as presented in the following description combines what might be considered the best aspects of many types of manual therapy tools in a novel and improved manner. The point of contact is modeled after the therapist's knuckle. This structure is more oblong than round with a narrower point of contact, itself possessing an edge. This knuckle structure creates a more specific point of contact, allowing for deeper and more precise soft tissue manipulation. Greater precision allows for work in sensitive areas while avoiding pressure on fragile structures. At the same time the side of the knuckle provides a scraping edge that is broader than those traditionally offered in Gua Sha and Muscle Scraping tools. This allows the force and pressure to be more widely distributed. A greater distribution of force reduces the resulting bruising and swelling often considered to be the negative outcomes associated with self-massage.

In the embodiment presented, four knuckle structures are distributed around and embedded in a ball base at varying depths. This allows for differing depths of penetration and again, greater control. The protruding edges of the four knuckles structures from the ball also create a multitude of rounded and angled surfaces suitable for use in self-massage.

### BRIEF DESCRIPTION OF THE FIGURES

FIGS. 1A, 1B, 1C, and 1D are schematic representations of the Front, Side, Top, and Isometric views, respectively, of the unique point of contact of the preferred device referred to as the knuckle structure.

FIGS. 2A & 2B are schematic representations of Front and Isometric exploded views of the preferred device, respectively, which illustrate the arrangement of the knuckle structures around the ball base.

FIGS. 3A, 3B, 3C, and 3D are schematic representations of from Front, Side, Top, and Oblique views of the preferred device, respectively.

FIG. 4 is a use scenario of the preferred device for a Direct Compression type of massage.

FIG. 5 is a use scenario of the preferred device for a Cross Friction type of massage.

FIG. 6 is a use scenario of the preferred device for a Muscle Scraping type of massage.

FIG. 7 is a use scenario of the preferred device for a Lymphatic Drainage type of massage.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### 1. Unique Points of Contact for Massage Tools

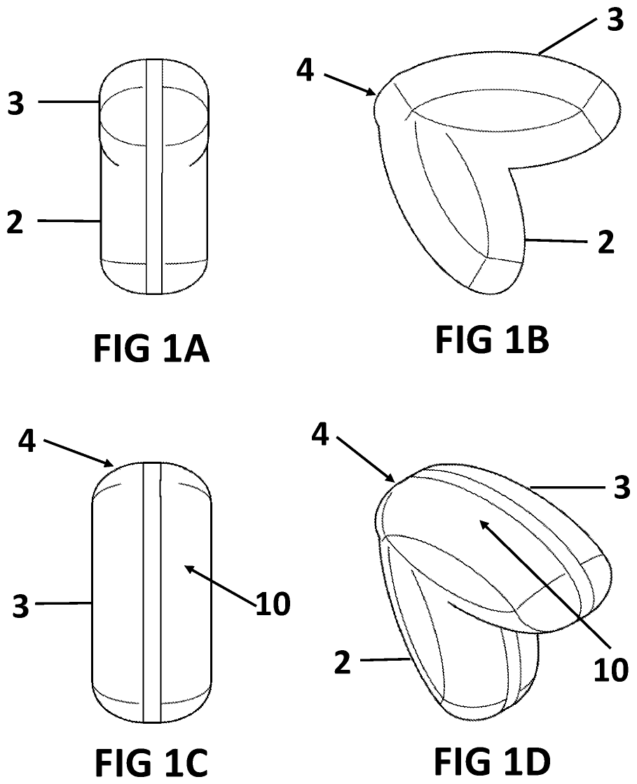

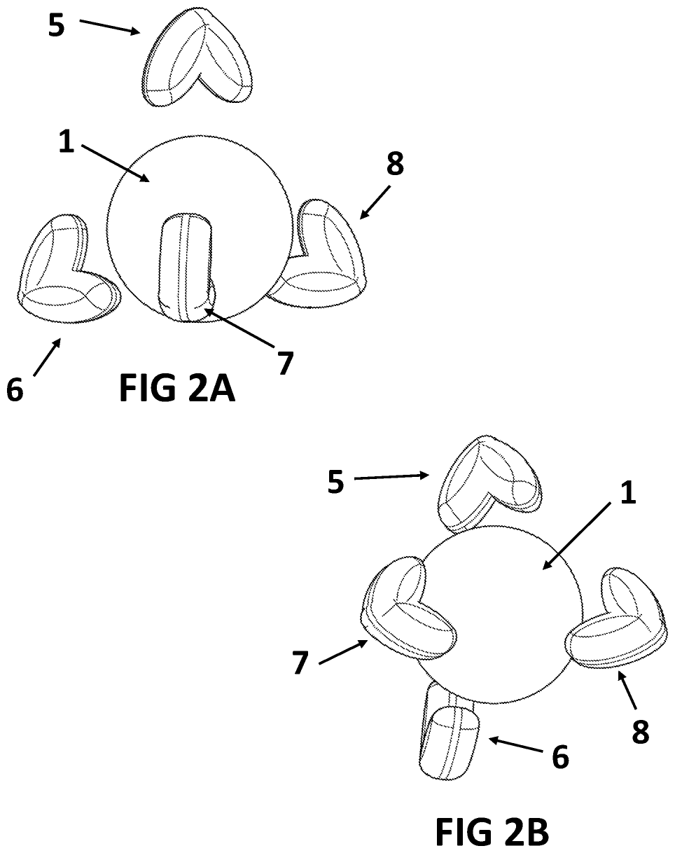

The Knuckle Structure, whose composition is shown in FIGS. 1A, 1B, 1C & 1D possesses a raised edge (COMPONENT 4) which is created by the overlapping of two oblong, ovoid bodies (COMPONENTS 2 and 3). This edge provides a specific point of contact that can be used for both Compressive and Cross-Friction types of Massage. Four such Knuckle Structures are arranged around a spherical or ball base in a tetrahedral arrangement as shown in FIGS. 2A and 2B.

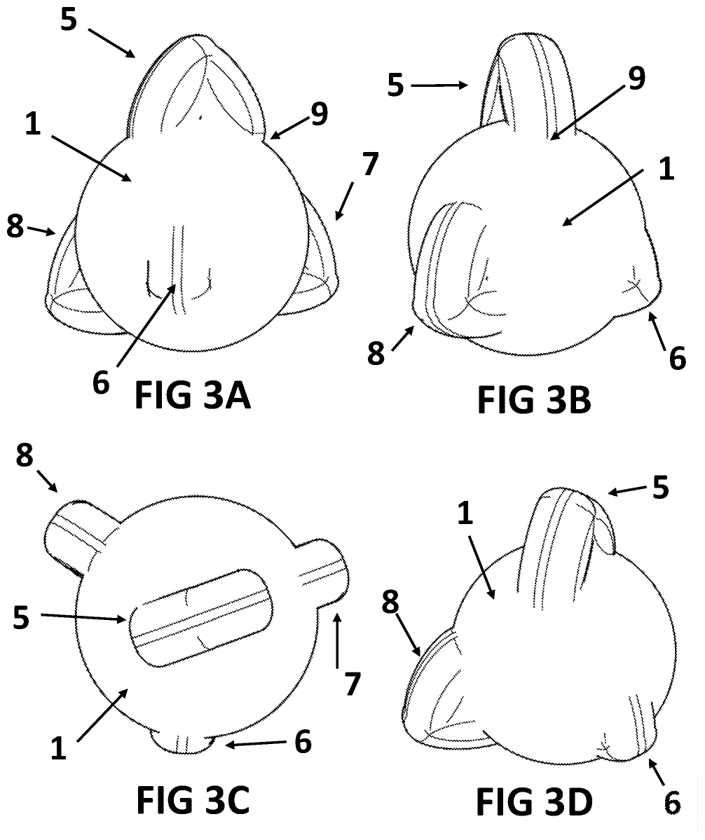

The Knuckle Structures are embedded in the ball base at staggered depths as shown in FIGS. 3A, 3B, 3C and 3D, thereby creating four points of contact with graduated lengths (COMPONENTS 5-8). A grooved edge (COMPONENT 9) is created by the juxtaposition of each Knuckle Structure and the ball base.

### 2. A Device for Compressive and Cross-Friction Types of Massage

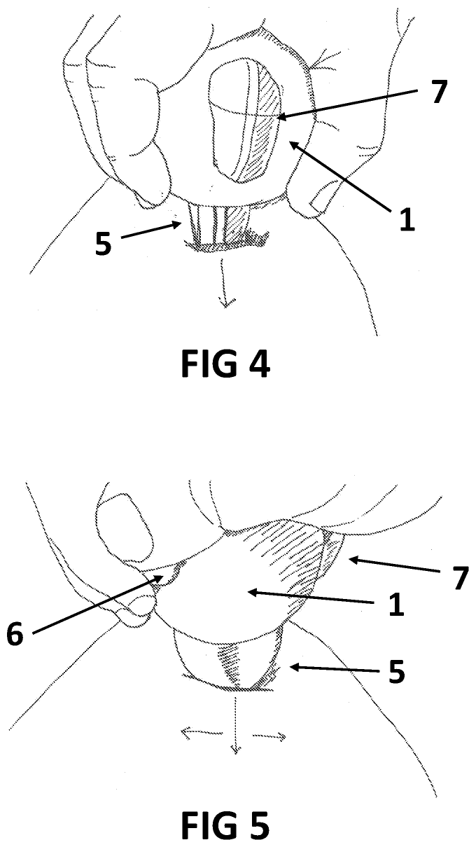

The assembled unit as shown in FIG. 3A is held by grasping the ball base (COMPONENT 1) opposite the Knuckle Structure (COMPONENTS 5-8) that is selected for therapeutic use. As demonstrated in FIG. 4, compressive force is created by pressing the Knuckle Structure directly into the muscle. Depth of penetration is controlled by both amount of force applied and by the length of which Knuckle Structure (COMPONENTS 5-8) is selected for use. The use of the edge (COMPONENT 4) of the selected Knuckle Structure to create compressive force is appropriate for use in Myofascial Release, Trigger Point Therapy, and Acupressure. As demonstrated in FIG. 5, a back and forth motion can be added to the compressive force to create a Cross-Friction type of Massage.

As shown in FIG. 3A, COMPONENT 5 is the longest and most prominent of the Knuckle Structures. It protrudes approximately 24 mm from the ball base (COMPONENT 1) and allows for the greatest depth of penetration of the four Knuckle Structures (COMPONENTS 5-8). This point of contact is appropriate for use on the largest muscles of the body such as the Gluteus Maximus, the Hamstrings, and the Quadriceps muscle groups.

As shown in FIG. 3C, COMPONENT 6 is the smallest and least prominent of the Knuckle Structures. It protrudes approximately 5 mm from the ball base (COMPONENT 1) and allows for the least depth of penetration of the four Knuckle Structures (COMPONENTS 5-8). This point of contact is appropriate for use on the smallest muscles of the body such as the muscles of mastication, the TMJ, and the Suboccipital muscles.

As shown in FIG. 3C, COMPONENT 7 is the next to smallest of the Knuckle Structures (COMPONENTS 5-8). It protrudes approximately 10 mm from the ball base (COMPONENT 1). This point of contact is appropriate for use on what might be considered midsized muscles of the body such as the muscles in the palm, bottom of the foot, and forearm.

As shown in FIG. 3C, COMPONENT 8 is the second largest of the Knuckle Structures. It protrudes approximately 15 mm from the ball base (COMPONENT 1). This point of contact is appropriate for use on what might be considered large muscles of the body such as the Trapezius, the Rhomboids, and the calf muscles.

### 2. A Device for Muscle Scraping Type of Massage

Each Knuckle Structure is comprised of two component parts (COMPONENTS 2 & 3) as shown in FIGS. 1A, 1B, 1C, and 1D. The outer fillet edges of these surfaces (COMPONENT 10) provide the point of contact to be used for muscle scraping. These surfaces are much broader (approximately 9 mm per side) than those typically provided in Gua Sha and Muscle Scraping tools (typically 1-3 mm). This allows the force of the pressure to be more widely distributed, thereby reducing the likelihood of breaking small underlying blood vessels which results in bruising.

The staggered lengths of the four Knuckle Structures (COMPONENTS 5-8) as shown in FIGS. 3A & 3C provide a multitude of potential scraping surfaces. The amount of force that can be applied with the edge of a Knuckle Structure (COMPONENT 10) is proportionate to its length. In other words, the longer the Knuckle Structure (COMPONENTS 5-8), the greater the amount of pressure can be applied. This allows the user to alternate between edges (COMPONENT 10) as needed for greater comfort and level of control.

### 3. Device for Lymphatic Drainage Massage

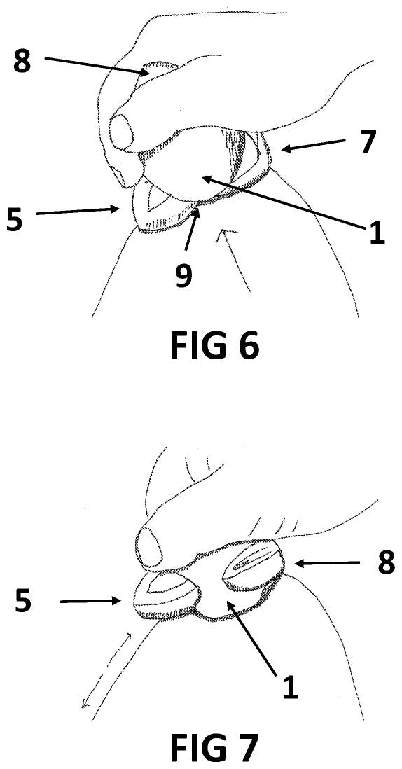

Multiple angles (COMPONENT 9) are created by the juxtaposition of each of the Knuckle Structures (COMPONENTS 5-8) and the Ball Base (COMPONENT 1) as shown in FIGS. 3A and 3B. These angles and the Ball Base itself are designed for use in Lymphatic Drainage Massage. The ball base is grasped in the hand, and the selected surface is gently applied to the treatment area. Long strokes towards the heart help to push the accumulated lymph fluid back into circulation as demonstrated in FIGS. 6 and 7.

Variations in the preferred embodiment may include but not be limited to an adjustment in size to accommodate different sized hands, an adjustment of the length of protrusion of the Knuckle Structures from the Ball Base, a differently shaped base, or a differing arrangement of Knuckle Structures around the base. The preferred embodiment may also be made hollow so as to allow filling with water and freezing. The material from which the preferred embodiment is manufactured could also vary considerably. The preferred embodiment could be carved from stone, blown from glass, turned or carved from wood, extruded from plastic, or made by injection molding.

As a person skilled in the art will recognize from the previous detailed description and from the figures and claims, modifications and changes can be made to the preferred embodiments of the invention without departing from the scope of this invention as defined in the following claims.

We claim:

1. A unique point of contact for massage therapy devices modeled after the human knuckle, comprising:
a. two intersecting fillet ovoid bodies whose heads closely overlap and whose bases form an approximately a 65-degree angle, where
b. the head of one ovoid body slightly protrudes through the other producing a narrow and softly edged point of contact,
whereby the described point of contact allows for the very specific and controlled manual application of force, and
whereby the described point of contact may be mounted on a variety of handles or bodies for use in manual massage therapy devices.

2. A unique point of contact for massage therapy devices, comprising:
a. the ovoid bodies which create the point of contact described in claim 2, where
b. the side edges of the ovoid bodies provide a firm rounded edge, and
whereby this rounded edge may be used as a point of contact in manual massage therapy devices.

3. A hand-held device for manual massage therapy, comprising:
a. A spherical base which fits easily in the hand to allow for a comfortable grip and a high level of control, and
b. multiple points of contact as described in claims 1 and 2 distributed around the spherical base in a tetrahedral arrangement, and
c. embedded in the spherical base at staggered depths,
whereby each point of contact produces a different depth of penetration into the structure being massaged.

4. A unique point of contact for massage therapy devices, comprising:
the angle created between each point of contact as descried in claim 1 and the sphere base as described in claim 3, and
whereby the rounded edge between the two bodies produces a surface suitable for either vigorous or more gentle types of stroking massage depending on the amount of force applied.

5. A method for direct compression massage, wherein the device described in claim 3:
a. provides specific direct compression of tight muscle fibers and fascia by the operator pushing the point of contact described in claim 1 directly into a muscle or soft tissue structure, and
b. provides diffuse type direct compression of soft tissue structures by the operator pushing the spherical base described in claim 3 directly into the soft tissue structure, and
whereby direct compression of soft tissue structures causes a localized loosening of tight muscle fibers, tendon fibers, and fascia.

6. A method for trigger point massage, wherein the device from claim 3:
a. provides direct compression of a painful knot within a muscle body with the point of contact described in claim 1, and
b. produces of a pain referral pattern through direct compression of the described painful knot,
whereby sustained compression gradually decreases and eliminates the described pain and referral pattern.

7. A method for Acupressure, wherein the device from claim 3:
provides direct compression of a tender point along a meridian line with the specific point of contact described in claim 1,
whereby sustained compression of the tender point increases energetic flow through the treatment area.

8. A method of cross-friction massage, wherein the device from claim 3:
provides a scraping type of force with the point of contact described in claim 1, and
whereby the application of such force causes a breakdown of scar tissue and increase in circulation at the point of contact.

9. A method of muscle scraping, wherein the device from claim 3:
provides a scraping type of force with the point of contact described in claim 2, and
whereby the application of such for causes a breakdown of scar tissue and increase in circulation at the point of contact.

10. A method of lymphatic drainage massage, wherein the device from claim 3:
Produces a gentle stroking pressure with the point of contact described in claim 4, and
whereby the headward application of gentle force stimulates movement of stagnant inflammation back into the lymphatic system.
